(19) United States
(12) Patent Application Publication
(10) Pub. No.: US 2017/0335024 A1
(43) Pub. Date: Nov. 23, 2017

(54) RUBBER COMPOSITION COMPRISING A PHOSPHONATE-FUNCTIONALIZED POLYENE COPOLYMER, AND USE OF SUCH A COPOLYMER FOR IMPROVING FILLER-DIENE ELASTOMER INTERACTIONS

(71) Applicants: COMPAGNIE GENERALE DES ETABLISSEMENTS MICHELIN, Clermont-Ferrand (FR); MICHELIN RECHERCHE ET TECHNIQUE, S.A., Granges-Paccot (CH)

(72) Inventors: Claire RANNOUX, Lausanne (CH); Rachid MATMOUR, Clermont-Ferrand Cedex 9 (FR); Anne-Frédérique SALIT, Clermont-Ferrand Cedex 9 (FR); Cédric LOUBAT, Castries (FR); Gilles BOUTEVIN, Castries (FR)

(21) Appl. No.: 15/527,170

(22) PCT Filed: Nov. 17, 2015
(86) PCT No.: PCT/FR2015/053097

§ 371 Date: May 16, 2017

(30) Foreign Application Priority Data
Nov. 17, 2014 (FR) 1461069

(51) Int. Cl. C08F 8/12; C08F 236/08; C08F 236/06; C08F 230/02; C08F 212/08; C08L 9/00; C08C 19/36

(52) U.S. Cl. CPC C08F 8/12; C08L 9/00; C08F 236/08; C08C 19/36; C08F 230/02; C08F 212/08; C08F 236/06

(57) ABSTRACT

Compositions comprising phosphonate-functionalized polyene copolymers and a reinforcing filler, in particular rubber compositions, and to their uses is provided.

This phosphonate-functionalized polyene copolymer comprises, in its main linear chain, unsaturated units resulting from at least one conjugated polyene monomer and units substituted by a —C(O)O-A-P(O)OR₁OR₂ functional group, in which R₁ and R₂, which are identical or different, each represent H or a C₁-C₆ alkyl and A represents a (C₁-C₆)alkylene radical or a (C₁-C₅)alkylene radical containing at least one heteroatom.

The use of this copolymer in a tire composition additionally comprising a diene elastomer and a reinforcing filler, for improving the interactions between the filler and the diene elastomer included in the said tire composition is also provided.

This application is a 371 national phase entry of PCT/FR2015/053097, filed 17 Nov. 2015, which claims benefit of French Patent Application No. 1461069, filed 17 Nov. 2014, the entire contents of which are incorporated herein by reference for all purposes.

### BACKGROUND

### 1. Technical Field

The invention relates to compositions comprising phosphonate-functionalized polyene copolymers and to their uses.

### 2. Related Art

Phosphorus-based polymers have recently gained increasing interest due to their utility in a wide range of applications, such as, for example, fuel cells, electrolyte membranes (cation-exchange membranes), flame retardants, coating additives, biomaterials, in particular in orthopaedic applications, the solubilization of medicaments, for example hydrogels for the release of medicaments, promoters of cell proliferation, corrosion-inhibiting agents in cooling systems, among others.

More specifically, it has been discovered that the introduction of functional groups derived from phosphonic acid onto elastomers used in tire compositions makes it possible to improve the interactions between the rubber and the fillers.

Several approaches have already been envisaged in order to obtain diene polymers functionalized with phosphonate groups.

Thus, the radical copolymerization of a diene and of vinyl phosphonate has been envisaged (Journal of Polymer Science (1952), 8, 255-6; FR 1403732). However, the authors report difficulties in introducing the phosphonate monomer into the polymer chain.

Others provide for the modification of the polymer after polymerization. These processes require two stages: polymerization and then post-modification. The post-polymerization modification can, for example, be a hydrophosphorylation (Advanced Synthesis & Catalysis (2008), 350, (3), 431-438; the catalysts used are expensive), a radical addition of HS—(CH₂)₃—PO(OC₂H₅)₂ (Polym. Bull., 1998, 41, 145-151; such a process operates mainly on diene polymers rich in 1,2-functional groups), an addition of ethyl phosphonate HPO(OEt)₂ to the carbon-carbon unsaturations of a polybutadiene (European Polymer Journal, Volume 19, Issue 12, Pages 1159-65, 1983; crosslinking side reactions are observed).

Yet others provide for a functionalization at the chain end (European Polymer Journal, Volume 17, Issue 4, pp 407-11, 1981) with the disadvantage that just one functional group can be introduced per chain.

The application WO 2006/114125 A1 relates to a rubber composition comprising at least one diene polymer, at least one reinforcing silica filler and at least one modified polycarboxylate. The use of phosphonate-functionalized polyene copolymers is not described or suggested therein.

The patent EP 0 278 029 describes (hydroxy)phosphinylalkyl acrylates or (dihydroxy)phosphinylalkyl acrylates. These compounds can be used in the preparation of a polymer composition involving the reaction of the said phosphinylalkyl acrylate with a polymerizable 1,2-ethylenic compound. However, no use of these compounds for an application in the field of rubber compositions has been envisaged.

### SUMMARY

Thus, the invention provides novel rubber compositions comprising functionalized polyene polymers bearing phosphonate functional groups and a simple method for the synthesis of such polymers. The synthesis process makes it possible to obtain, in one stage, a polyene polymer having phosphonate or phosphonic acid subunits distributed along the chain.

### DETAILED DESCRIPTION OF EXAMPLE EMBODIMENTS

Definitions:

“(C₁-C₆)alkylene” or “(C₁-C₆)alkanediyl” group is understood to mean, within the meaning of embodiments of the present invention, a linear or branched divalent hydrocarbon chain comprising from 1 to 6 carbon atoms, such as, for example, a methylene, ethylene, propylene, butylene, pentylene or hexylene group. This group can in addition be substituted.

“(C₁-C₅)alkylene containing at least one heteroatom” group is understood to mean, within the meaning of embodiments of the present invention, a linear or branched divalent hydrocarbon chain comprising from 1 to 5 carbon atoms and at least 1 heteroatom. This group can in addition be substituted. The heteroatom is advantageously chosen from O, S and N. Advantageously, the group comprises at most two heteroatoms. In the case where the heteroatom is nitrogen, the latter will in addition be substituted by a hydrogen atom or a (C₁-C₆)alkyl radical.

“(C₁-C₆)alkyl” group is understood to mean, within the meaning of embodiments of the present invention, a saturated and linear or branched hydrocarbon chain comprising from 1 to 6, preferably from 1 to 4, carbon atoms. Mention may be made, by way of example, of the methyl, ethyl, propyl, butyl, pentyl or hexyl groups.

“Phosphonate” is understood to mean, within the meaning of embodiments of the present invention, a P(O)OR₁OR₂ functional group, where R₁ and R₂, which are identical or different, each represent H or a C₁-C₆ alkyl. Thus, by misuse of language, the term phosphonate also encompasses the phosphonic acid functional group.

“phr” means parts by weight per hundred parts of total elastomer, thus including the polyene copolymer bearing phosphonate functional groups.

Any interval of values denoted by the expression “between a and b” represents the range of values extending from more than a to less than b (that is to say, limits a and b excluded), whereas any interval of values denoted by the expression “from a to b” means the range of values extending from a to b (that is to say, including the strict limits a and b).

The rubber composition according to embodiments of the present invention comprises a phosphonate-functionalized polyene copolymer, characterized in that it comprises, in its main linear chain, unsaturated units resulting from at least one conjugated polyene monomer and units substituted by a —C(O)O-A-P(O)OR₁OR₂ functional group, in which R₁ and R₂, which are identical or different, each represent H or a C₁-C₆ alkyl and A represents a (C₁-C₆)alkylene radical or a (C₁-C₃)alkylene radical containing at least one heteroatom.

The units substituted by a —C(O)O-A-P(O)OR₁OR₂ functional group are also denoted phosphonate functional units.

According to embodiments of the invention, the alkylene radical can be substituted by one or more —X—(R₃)(R₄)ₙ radicals, where:
X represents a heteroatom(s) chosen from O, S and N,
R₃ and R₄, which are identical or different, each represent a hydrogen atom or a (C₁-C₆)alkyl radical,
n represents 0 or 1 as a function of the valency of the heteroatom,
A advantageously represents an unsubstituted (C₁-C₆)alkylene radical, in particular a methylene or ethylene radical.

Advantageously, R₁ and R₂, which are identical or different, each represent H or CH₃.

In the copolymer according to embodiments of the invention, the substituted units advantageously result from a monomer corresponding to the following formula (I):

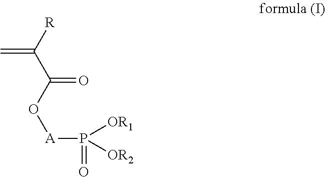

in which:
R represents H or CH₃,
A, R₁ and R₂ are as defined above.

These monomers are commercially available or can be synthesized by a person skilled in the art on the basis of his general knowledge. In particular, phosphonate or phosphonic acid (meth)acrylates are commercially available or can be prepared at low temperature from inexpensive reactants and without risk. For example:

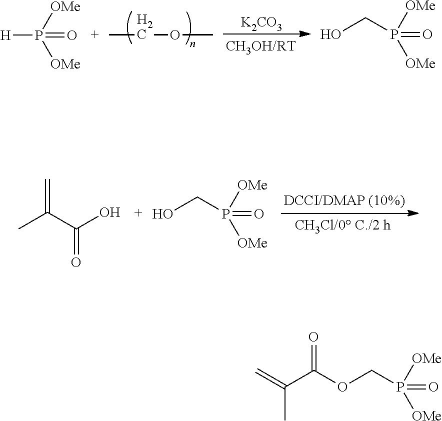

The copolymer according to embodiments of the invention advantageously comprises from 0.1 to 30 mol % of units substituted by a —C(O)O-A-P(O)OR₁OR₂ functional group, more advantageously from 0.1 to 20 mol % and more advantageously still from 1 to 20 mol % of the said units.

The conjugated polyene monomer is advantageously a conjugated diene. Use may be made, according to embodiments of the invention, of any conjugated diene monomer having from 4 to 12 carbon atoms. The following are suitable in particular as conjugated dienes: 1,3-butadiene, 2-methyl-1,3-butadiene (also denoted isoprene), 2,3-di(C₁ to C₅ alkyl)-1,3-butadiene, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene or 2,4-hexadiene. Preference is very particularly given to 1,3-butadiene or isoprene.

According to embodiments of the invention, the diene monomer can be inserted according to an enchainment of 1,4-type or of 1,2-type, advantageously randomly and independently.

The copolymer according to embodiments of the invention advantageously comprises from 1 to 99.9 mol % of units resulting from conjugated polyene monomer, more advantageously from 1 to 95 mol % and more advantageously still from 10 to 95 mol % of the said units.

The copolymer can comprise, besides these unsaturated units resulting from conjugated polyene monomer and these phosphonate functional units, units resulting from another monomer. The other monomer is advantageously an ethylenic monomer, in particular:
a vinylaromatic compound having from 8 to 20 carbon atoms, such as, for example, styrene, ortho-, meta- or para-methylstyrene, divinylbenzene or vinylnaphthalene, preferably styrene,
a vinyl nitrile monomer having from 3 to 12 carbon atoms, such as acrylonitrile or methacrylonitrile or their mixtures,
an acrylic ester monomer derived from the reaction of an acrylic acid or of a methacrylic acid with an alcohol having from 1 to 12 carbon atoms, such as, for example, methyl acrylate, ethyl acrylate, propyl acrylate, n-butyl acrylate, isobutyl acrylate, 2-ethylhexyl acrylate, methyl methacrylate, ethyl methacrylate, n-butyl methacrylate or isobutyl methacrylate,
a carboxylic acid vinyl ester monomer having from 1 to 24 carbon atoms, such as, for example, vinyl acetate and vinyl propionate,
or a mixture of these monomers.

The copolymer according to embodiments of the invention advantageously comprises from 0 to 50 mol % of units resulting from ethylenic monomer, more advantageously from 0 to 30 mol % and more advantageously still from 0 to 20 mol %.

The copolymer according to embodiments of the invention can be a block, random or gradient copolymer. Advantageously, it is a random copolymer which comprises, within its main linear chain, units resulting from one or more conjugated polyene monomers and units resulting from one or more monomers substituted by a —C(O)O-A-P(O)OR₁OR₂ functional group which are randomly distributed.

The invention also describes a process for the synthesis of a phosphonate-functionalized polyene copolymer, characterized in that it comprises a stage of copolymerization (a) of a conjugated polyene monomer and (b) of a monomer substituted by a —C(O)O-A-P(O)OR₁OR₂ functional group, where R₁, R₂ and A are as defined above.

Advantageously, in addition, at least one other monomer copolymerizes during the copolymerization stage. This other monomer is as described above.

The copolymerization is advantageously carried out by the radical route. The synthesis process comprises a stage of copolymerization (a) of a conjugated polyene monomer and (b) of a monomer substituted by a —C(O)O-A-P(O)OR₁OR₂ functional group, where A, R₁ and R₂ are as defined above, and optionally (c) of another monomer.

The polymerization can be carried out in solution, in emulsion or in suspension. The polymerization is advantageously carried out in emulsion in water in the presence of a surfactant, of an initiator and of a pH buffer.

Alternatively, the copolymer can also be prepared by copolymerization of at least one block resulting from the polymerization of the conjugated polyene and of at least one block comprising at least one unit substituted by a —C(O)O-A-P(O)OR₁OR₂ functional group, where A, R₁ and R₂ are as defined above.

If appropriate, the process comprises, subsequent to the polymerization stage, a stage of complete or partial hydrolysis of the P(O)OR₁OR₂ functional groups. Thus, the phosphonate functional groups can be partially or completely, advantageously partially, hydrolysed post-polymerization in order to result in particular in the polyene copolymer bearing phosphonic monoacid functional group. The hydrolysis can, for example, be carried out by addition of an alkali metal halide and then of an alcohol.

This process makes it possible to introduce a significant number of phosphonate functional groups, along the chain of the polyene, in a simple and inexpensive way.

The copolymer according to embodiments of the invention is used in a rubber composition, in particular a composition for tires, as elastomeric component of this composition or as additive.

The invention relates to a rubber composition, comprising the polyene copolymer bearing phosphonate functional groups according to embodiments of the invention and a reinforcing filler.

Advantageously, the rubber composition also comprises a second polymer which is a diene elastomer.

It is restated here that “elastomer” of the “diene” type should be understood, in a known way, as an elastomer resulting at least in part (i.e., a homopolymer or a copolymer) from diene monomers (monomers bearing two conjugated or non-conjugated carbon-carbon double bonds).

Diene elastomer should be understood, according to embodiments of the invention, as meaning any synthetic elastomer resulting, at least in part, from diene monomers. More particularly, diene elastomer is understood as meaning any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter contain from 20% to 99% by weight of diene units and from 1% to 80% by weight of vinylaromatic units.

The diene elastomer is an elastomer conventionally used in compositions which are used in the manufacture of tires.

Thus, the diene elastomer of the composition in accordance with embodiments of the invention is preferably selected from the group of diene elastomers consisting of polybutadienes, synthetic polyisoprenes, natural rubber, butadiene copolymers, isoprene copolymers and the mixtures of these elastomers. Such elastomers are more preferably selected from the group consisting of styrene copolymers (butadiene/styrene copolymers (SBRs), butadiene/isoprene copolymers (BIRs), isoprene/styrene copolymers (SIRs), butadiene/styrene/isoprene copolymers (SBIRs)), polybutadienes (BRs), polyisoprenes (IRs) and natural rubber (NR).

The rubber composition advantageously comprises more than 70 phr of the phosphonate-functionalized polyene copolymer.

The composition also comprises a reinforcing filler.

Use may be made of any type of reinforcing filler known for its abilities to reinforce a rubber composition which can be used in the manufacture of tires, for example an organic filler, such as carbon black, a reinforcing inorganic filler, such as silica, or else a blend of these two types of filler, in particular a blend of carbon black and of silica.

All the carbon blacks conventionally used in tires (“tire-grade” blacks) are suitable as carbon blacks.

“Reinforcing inorganic filler” should be understood, in the present patent application, by definition, as meaning any inorganic or mineral filler (whatever its colour and its origin, natural or synthetic), also known as “white filler”, “clear filler” or indeed even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known way, by the presence of hydroxyl (—OH) groups at its surface.

The physical state in which the reinforcing inorganic filler is provided is not important, whether it is in the form of a powder, of micropearls, of granules, of beads or any other appropriate densified form. Of course, reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes. Use is made in particular of silane polysulphides, referred to as “symmetrical” or “asymmetrical” depending on their specific structure, such as described, for example, in Applications WO 03/002648 (or US 2005/016651) and WO 03/002649 (or US 2005/016650).

Finally, a person skilled in the art will understand that, as filler equivalent to the reinforcing inorganic filler described in the present section, use might be made of a reinforcing filler of another nature, in particular organic nature, provided that this reinforcing filler is covered with an inorganic layer, such as silica, or else comprises functional sites, in particular hydroxyl sites, at its surface which require the use of a coupling agent in order to establish the bond between the filler and the elastomer.

The content of total reinforcing filler (carbon black and/or reinforcing inorganic filler, such as silica) is between 0 and 120 phr, more preferably between 0 and 70 phr, more particularly ranges from 5 to 70 phr and more preferably also between 0 and 50 phr and very preferably ranges from 5 to 50 phr, the optimum being, of course, different according to the specific applications targeted.

The rubber compositions in accordance with embodiments of the invention can also comprise all or a portion of the normal additives customarily used in elastomer compositions intended for the manufacture of tires, such as, for example, pigments, protective agents, such as antiozone waxes, chemical antiozonants or antioxidants, antifatigue agents, reinforcing or plasticizing resins, methylene acceptors (for example, phenolic novolak resin) or methylene donors (for example, HMT or H3M), such as described, for example, in Application WO 02/10269, a crosslinking system based either on sulphur or on sulphur donors and/or on peroxide and/or on bismaleimides, vulcanization accelerators, vulcanization activators, adhesion promoters, such as cobalt-based compounds, plasticizing agents, preferably non-aromatic or very slightly aromatic plasticizing agents selected from the group consisting of naphthenic oils, paraffinic oils, MES oils, TDAE oils, ether plasticizers, ester plasticizers (for example glycerol trioleates), hydrocarbon resins exhibiting a high Tg, preferably of greater than 30° C., such as described, for example, in Applications WO 2005/087859, WO 2006/061064 and WO 2007/017060, and the mixtures of such compounds.

Another subject matter of the invention is a tire which incorporates, in at least one of its constituent components, a rubber composition, advantageously a reinforced rubber composition, according to embodiments of the invention.

Another subject matter of the invention is the use of a phosphonate-functionalized polyene copolymer according to embodiments of the invention in a tire composition additionally comprising a diene elastomer and a reinforcing filler, for improving the interactions between the filler and the diene elastomer included in the said tire composition.

### EXAMPLES

Measurements Used:

Nuclear Magnetic Resonance (NMR):

Copolymers Synthesized in Emulsion:

The contents of the different monomer units and their microstructures within the copolymer are determined by an NMR analysis. The spectra are acquired on a Bruker 500 MHz spectrometer equipped with a 5 mm BBI Z-grad “broad band” probe. The quantitative ¹H NMR experiment uses a simple 30° pulse sequence and a repetition time of 3 seconds between each acquisition. The samples are dissolved in deuterated chloroform (CDCl₃) or deuterated methanol (MeOD).

Copolymers Synthesized in Solution:

The ¹H NMR analyses are carried out with a Bruker Avance 300 (300 MHz) spectrometer, QNP ¹H, ³¹P, ¹⁹F and ¹³C probe. The samples are dissolved in deuterated chloroform (CDCl₃).

Size Exclusion Chromatography (SEC):

Size exclusion chromatography (SEC) is used. SEC makes it possible to separate macromolecules in solution according to their size through columns filled with a porous gel. The macromolecules are separated according to their hydrodynamic volume, the bulkiest being eluted first.

Without being an absolute method, SEC makes it possible to comprehend the distribution of the molar masses of a polymer. The various number-average molar masses (Mn) and weight-average molar masses (Mw) can be determined from commercial standards and the polymolecularity or polydispersity index (PI=Mw/Mn) can be calculated via a “Moore” calibration.

Preparation of the polymer: There is no specific treatment of the polymer sample before analysis. The latter is simply dissolved, in tetrahydrofuran+1 vol % of diisopropylamine+1 vol % of triethylamine+0.1 vol % of distilled water or in chloroform, at a concentration of approximately 1 g/l. The solution is then filtered through a filter with a porosity of 0.45 μm before injection.

SEC analysis: The apparatus used is a “Waters Alliance” chromatograph. The elution solvent is tetrahydrofuran+1 vol % of diisopropylamine+1 vol % of triethylamine or chloroform, according to the solvent used for the dissolution of the polymer. The flow rate is 0.7 ml/min, the temperature of the system is 35° C. and the analytical time is 90 min. A set of four Waters columns in series, with commercial names “Styragel HMW7”, “Styragel HMW6E” and two “Styragel HT6E”, is used.

The volume of the solution of the polymer sample injected is 100 μl. The detector is a “Waters 2410” differential refractometer and the software for making use of the chromatographic data is the “Waters Empower” system.

The calculated average molar masses are relative to a calibration curve produced from “PSS Ready Cal-Kit” commercial polystyrene (PS) standards.

Unless indicated otherwise, all the percentages shown are percentages by weight.

### EXAMPLES OF THE PREPARATION OF PHOSPHONATE OR PHOSPHONIC ACID FUNCTIONAL COPOLYMERS

### Example 1

### Isoprene/Dimethyl (Methacryloyloxy)methylphosphonate (MAPC1) Radical Solution Copolymerization

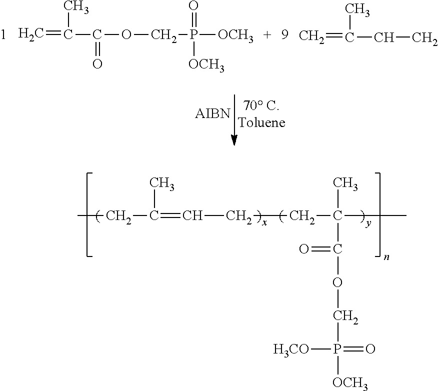

38 g of dimethyl (methacryloyloxy)methylphosphonate, 112 g of isoprene, 100 g of toluene and 3.21 g of azobisisobutyronitrile (AIBN) are introduced under a stream of argon into an autoclave reactor. The reaction mixture is heated and stirred at 70° C. overnight. The conversion to give polymer is 45%. The copolymer is precipitated from methanol.

The composition of the copolymer is determined by NMR. The copolymer thus has the following composition: 84 mol % of isoprene−16 mol % of MAPC1.

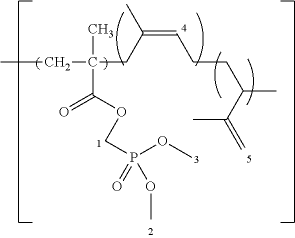

The polymer is analysed by ¹H NMR (CDCl₃). The data are given in the following table:

TABLE 1

| Proton No. | Chemical shift (ppm) | Number of protons |
|---|---|---|
| H1 | 4.15-4.55 | 2 |
| H2, H3 | 3.75-4 | 6 |
| H4, H5 | 4.55-5.40 | 3 |

The polymer is analysed by ³¹P NMR (CDCl₃). The data are given in the following table:

TABLE 2

| | Chemical shift (ppm) | Phosphorus number |
|---|---|---|
| P | 20.5-24 | 1 |

The molar mass of the copolymer is determined by SEC: Mn (PS eq)=3660 g/mol; Mw (PS eq)=5980 g/mol; PI=1.63. There are approximately 7 methyl phosphonate functional groups per chain.

### Example 2

### Monohydrolysis of the Poly(isoprene-co-MAPC1) Copolymer

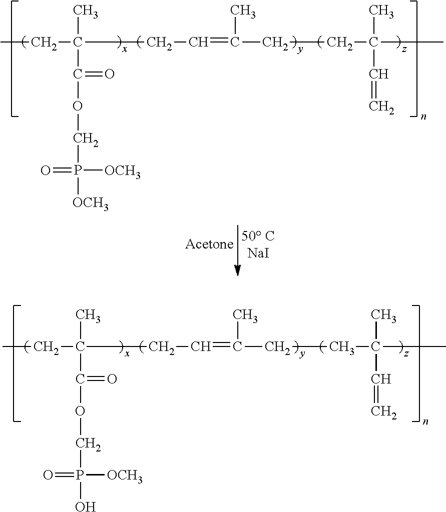

37 g of poly(isoprene-co-MAPC1) copolymer are dissolved in acetone. 11.5 g of NaI are added. The reaction mixture is stirred and heated at 50° C. The reaction is monitored in kinetics by NMR. When the conversion is complete (decrease by a factor of 2 in the integration value of the —POCH₃ at 3.8 ppm by ¹H NMR), the polymer, which precipitates in the form of sodium salts, is recovered and then washed with acetone to remove the NaI residues. The polymer is subsequently dissolved in methanol and then Amberlite IR-120 is added. The reaction medium is stirred at ambient temperature for 1 h, then filtered to remove the Amberlite and finally evaporated. The final product is a viscous liquid obtained with a yield of 90%.

¹H and ³¹P NMR make it possible to confirm the structure of the product (spectrum produced in MeOD).

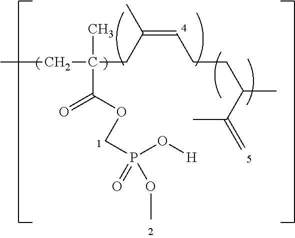

The data are given in the following table:

TABLE 3

| Proton No. | Chemical shift (ppm) | Number of protons |
|---|---|---|
| H1 | 4.15-4.50 | 2 |
| H2 | 3.65-3.95 | 3 |
| H4, H5 | 4.65-5.40 | 3 |

The polymer is analysed by ³¹P NMR. The data are given in the following table:

TABLE 4

| | Chemical shift (ppm) | Phosphorus number |
|---|---|---|
| P | 18 | 1 |

The molar mass of the copolymer is determined by SEC: Mn (PS eq)=3660 g/mol; Mw (PS eq)=5980 g/mol; PI=1.63. There are approximately 7 methyl phosphonate functional groups per chain.

### Example 3

### Styrene/Butadiene/Dimethyl (Methacryloyloxy)methylphosphonate (MAPC1) Radical Emulsion Copolymerization

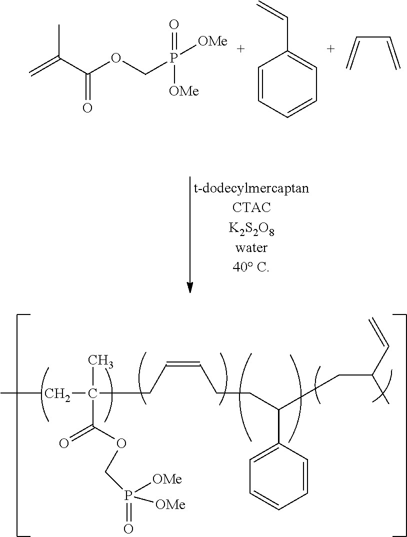

Radical emulsion polymerization is carried out in a capped bottle with moderate stirring and under an inert nitrogen atmosphere.

0.120 g of K₂S₂O₈ and 0.5 g of hexadecyltrimethylammonium chloride are introduced into a bottle. The bottle is capped and then sparged with nitrogen for 10 min. The following compounds and solutions (these solutions having been sparged to remove any trace of oxygen) are subsequently successively introduced into the bottle:
90 ml of water,
127 μl of a 0.7 mol/l solution of tert-dodecyl mercaptan in styrene,
additional 2.2 ml of styrene,
2.4 ml of MAPC1,
8.8 ml of butadiene.

The reaction medium is stirred and heated at 40° C. The polymerization is halted after 60% conversion by the addition of 1 ml of a 100 g/l solution of resorcinol in water.

A 50/50 acetone/methanol mixture is added to the reaction medium to coagulate the copolymer.

The copolymer is dried by placing in an oven under vacuum (200 torr) at 50° C. for 1 day.

The copolymer is analysed by NMR. The results are given in the following table:

TABLE 5

| | δ (¹H) | δ (¹³C) | δ (³¹P) | Number |
|---|---|---|---|---|
| Subunits | in ppm | in ppm | in ppm | of protons |
| CH₃—O—P | 3.4 to 3.7 | 53.0 | 21.1 | 6 |
| O—CH₂—P | 3.7 to 4.4 | 54.8 and 56.3 | | 2 |
| PB1-2 | 4.6 to 4.9 | 114 | | 2 + 1 |
| PB1-4 and PB1-2 | 4.9 to 5.5 | 142.8 to 124.5 | | 2 + 1 |
| Styrene | 6.8 to 7.2 | 125.8 to 127.6 | | 5 |

PB1-2: polybutadiene, enchainments of 1,2-type,

PB1-4: polybutadiene, enchainments of 1,4-type.

The polymer is analysed by SEC: Mn=82 814 g/mol (PS eq).

### Example 4

### Complete Hydrolysis of the Poly(styrene-co-butadiene-co-MAPC1) Copolymer

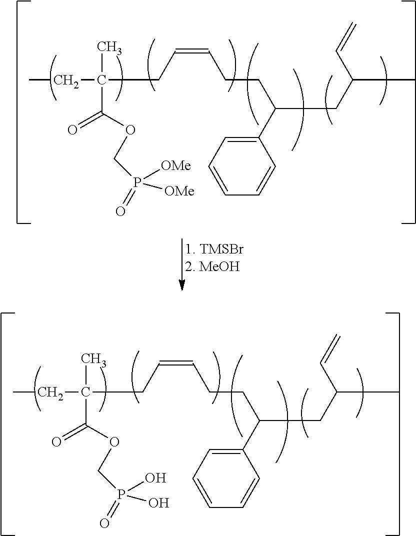

8.4 g of poly(styrene-co-butadiene-co-MAPC1) are dissolved in dichloromethane (80 ml) under an inert atmosphere and 4.18 g (0.0273 mol) of trimethylsilyl bromide are added to the reaction medium.

The reaction medium is heated at 40° C. Once complete conversion has been achieved (NMR monitoring), 500 ml of methanol are added in order to coagulate the polymer. The polymer is recovered and then washed 3 times with methanol.

The polymer is analysed by NMR.

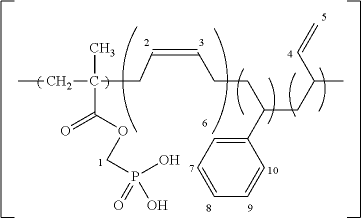

The data are given in the following table:

TABLE 6

| Proton No. | Chemical shift (ppm) | Number of protons |
|---|---|---|
| H1 | 4.15-4.40 | 2 |
| H2, H3, H4 | 5.10-6.25 | 3 |
| H5 | 4.75-5.05 | 2 |
| H6, H7, H8, H9, H10 | 6.9-7.4 | 5 |

The polymer is analysed by SEC: Mn=82 000 g/mol (PS eq).

1. A rubber composition, comprising:
a phosphonate-functionalized polyene copolymer, comprising, in its main linear chain, unsaturated units resulting from at least one conjugated polyene monomer and units substituted by a —C(O)O-A-P(O)OR₁OR₂ functional group, in which R₁ and R₂, which are identical or different, each represent a H or a C₁-C₆ alkyl and A represents a (C₁-C₆)alkylene radical or a (C₁-C₅)alkylene radical containing at least one heteroatom, and;
a reinforcing filler.

2. A rubber composition according to claim 1, wherein the substituted units of the phosphonate-functionalized polyene copolymer result from a monomer corresponding to the following formula (I): 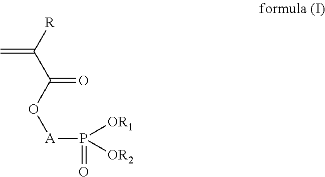
in which:
R represents H or CH₃,
A, R₁ and R₂ are as defined in claim 1.

3. A rubber composition according to claim 1, characterized in that wherein the conjugated polyene monomer of the phosphonate-functionalized polyene copolymer is a conjugated diene monomer.

4. A rubber composition according to claim 1, wherein the diene monomer is inserted according to an enchainment of 1,4-type or of 1,2-type.

5. A rubber composition according to claim 1, wherein the phosphonate-functionalized polyene copolymer comprises from 0.1 to 30 mol % of units substituted by a —C(O)O-A-P(O)OR₁OR₂ functional group, advantageously from 0.1 to 20 mol % of the said units.

6. A rubber composition according to claim 1, wherein the phosphonate-functionalized polyene copolymer comprises, besides the unsaturated units resulting from conjugated polyene monomer and the units substituted by a —C(O)O-A-P(O)OR₁OR₂ functional group, units resulting from another monomer.

7. A rubber composition according to claim 6, wherein the other monomer of the phosphonate-functionalized polyene copolymer is an ethylenic monomer.

8. A rubber composition according to claim 7, wherein the phosphonate-functionalized polyene copolymer comprises from 0 to 50 mol % of units resulting from ethylenic monomer.

9. A rubber composition according to claim 1, wherein the reinforcing filler is organic, inorganic or a mixture of an organic and inorganic filler.

10. A rubber composition according to claim 1, wherein the content of reinforcing filler is between 0 and 120 phr.

11. A rubber composition according to claim 1, wherein the phosphonate-functionalized polyene copolymer is a diene elastomer.

12. A rubber composition according to claim 1, additionally comprising a second polymer which is a diene elastomer.

13. A rubber composition according to claim 1, wherein an at least bifunctional coupling agent is used to couple the reinforcing inorganic filler to the diene elastomer.

14. A rubber composition according to claim 13, wherein the at least bifunctional coupling agent is selected from the group consisting of organosilanes, polyorganosiloxanes and silane polysulphides.

15. A tire composition comprising a phosphonate-functionalized polyene copolymer as defined in claim 1, and additionally comprising a diene elastomer and a reinforcing filler, for improving the interactions between the filler and the diene elastomer included in the tire composition.

16. A tire, at least one of the constituent components of which comprise a rubber composition according to claim 1.

17. A rubber composition according to claim 3, wherein the conjugated polyene monomer of the phosphonate-functionalized polyene copolymer is 1,3-butadiene or isoprene.

18. A rubber composition according to claim 5, wherein the phosphonate-functionalized polyene copolymer comprises from 0.1 to 20 mol % of units substituted by a —C(O)O-A-P(O)OR₁OR₂ functional group.

19. A rubber composition according to claim 7, wherein the other monomer of the phosphonate-functionalized polyene copolymer is selected from the group consisting of:
a vinylaromatic compound having from 8 to 20 carbon atoms, such as styrene,
a vinyl nitrile monomer having from 3 to 12 carbon atoms,
an acrylic ester monomer derived from acrylic acid or from methacrylic acid with an alcohol having from 1 to 12 carbon atoms,
a carboxylic acid vinyl ester monomer having from 1 to 24 carbon atoms, and
a mixture of these monomers.
